(19) United States
(12) Patent Application Publication
(10) Pub. No.: US 2007/0196706 A1
(43) Pub. Date: Aug. 23, 2007

(54) Fuel cell system

(76) Inventors: Hironori Sasaki, Hitachi (JP); Kenji Yamaga, Hitachi (JP); Katsunori Nishimura, Hitachiota (JP); Masahiro Komachiya, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/524,960

(22) Filed: Sep. 22, 2006

(30) Foreign Application Priority Data
Feb. 17, 2006 (JP) 2006-040113

(51) Int. Cl. H01M 8/04

(52) U.S. Cl. 429/22; 429/23; 429/24

(57) ABSTRACT

The fuel cell system comprises a fuel cell having an anode supplied with fuel gas and a cathode supplied with oxidizing agent gas, a water penetration membrane-type moistening device for collecting moisture contained in cathode off gas discharged from a cathode exit of the fuel cell and moistening oxidizing agent gas, and a moisture regulating means for regulating moisture contained in cathode off gas between the cathode exit of the fuel cell and the water penetration membrane-type moistening device, wherein when operating the fuel cell at more than a predetermined rated load of the fuel cell, moisture contained in cathode off gas is reduced by the moisture regulating means.

### CLAIM OF PRIORITY

The present application claims priority from Japanese application serial no. 2006-040113, filed on Feb. 17, 2006, the content of which is hereby incorporated by reference into this application.

### BACKGROUND OF THE INVENTION

1. Field of the Invention

The present invention relates to a fuel cell system having a fuel cell for generating electric energy by a chemical reaction of fuel gas and oxidizing agent gas.

2. Description of the Prior Art

Conventionally, a polymer electrolyte fuel cell (PEFC) has a main characteristic that a membrane electrode assembly (MEA) composed of a carbon electrode of a membrane-shaped solid electrolyte of high polymer molecules carrying a catalyst such as platinum is used. It has a structure that the carbon electrode is grasped by a pair of separators for forming a flow path of hydrogen gas and oxidizing agent gas (oxygen, air, etc.) as fuel and performing a current collecting action. This is referred to as a single cell and a fuel cell stack is composed of several laminated single cells.

Further, in a fuel cell system using such a polymer electrolyte fuel cell, to prevent the polymer electrolyte from drying at time of power generation, it is necessary to moisten oxidizing agent gas which is reaction gas. When moistening oxidizing agent gas (cathode gas), a fuel cell system using cathode off gas containing water generated when power is generated by the cathode of the fuel cell and moistening by moving moisture in cathode off gas to cathode gas using a water penetration membrane-type moistening device is proposed.

Cathode off gas which is discharged when cathode gas is reduced by the cathode contains generated water generated when the fuel cell generates power, and moisture contained in the cathode off gas greatly varies with the power generation condition of the fuel cell system, so that generally, in the rated load condition, the water incoming and outgoing balance in the fuel cell system is in a good state.

However, when the fuel cell is operated continuously, moisture may stay (flood). In such a case, to recover the reduction in the output of the fuel cell, it may be considered to bypass a part of cathode off gas and reduce the moistening amount of cathode gas (Japanese Patent Laid-open No. 2001-216984).

### SUMMARY OF THE INVENTION

Cathode off gas contains generated water generated when the fuel cell generates power. Therefore, the moisture contained in cathode off gas greatly varies with the power generation condition of the fuel cell system. However, generally, in the rated load condition, a moistening device and a gas-liquid separator are installed to keep the water incoming and outgoing balance in a good state. Therefore, when a load equal to or more than the rated load current is temporarily applied to the fuel cell, the generated water amount increases, and the moistening amount of cathode gas moistened by the water penetration membrane-type moistening device for collecting and moistening the generated water is accumulated, thus flooding is easily caused. As a result, water stays in the fuel cell, and the water blocks the flow path of reaction gas of the fuel cell, so that each cell voltage is varied, and the power generation condition becomes unstable.

The present invention provides a fuel cell system, before the system is put into a state that flooding is easily caused when the power generation condition of the fuel cell becomes the overload condition, for controlling beforehand so as to keep the water incoming and outgoing balance in the fuel cell in an appropriate state.

The fuel cell system includes a fuel cell for oxidizing fuel gas, reducing oxidizing agent gas, thereby generating power and a water penetration membrane-type moistening device for collecting moisture contained in cathode off gas composed of the reduced oxidizing agent gas and moistening the oxidizing agent gas before reduction, wherein a moisture regulating means for regulating the moisture contained in the cathode off gas is installed on a pipe connected it to the fuel cell and when the fuel cell is operated at more than a predetermined rated load of the fuel cell, the moisture contained in the cathode off gas is reduced by the moisture regulating means.

Here, the rated load is a load value for realizing the system output value decided by the system required specification. When operating the fuel cell system, particularly in the mobile body, the necessary load value changes with time and among those values, the value of load for realizing the average output value necessary for a given period of time is decided as a rate load.

According to the present invention, when the power generation condition of the fuel cell becomes the overload condition, a fuel cell system controlled beforehand so as to keep the water incoming and outgoing balance in the fuel cell in an appropriate state can be provided.

### BRIEF DESCRIPTION OF THE DRAWINGS

FIG. 1 is a schematic view of the fuel cell system of an embodiment of the present invention.

FIG. 2 is a schematic view of the fuel cell system of an embodiment of the present invention.

FIG. 3 is a schematic view of the fuel cell system of a comparison embodiment of the present invention.

FIG. 4 is I-V characteristic curves when the embodiment of the present invention is used.

FIG. 5 is a block diagram of the fuel cell system of an embodiment of the present invention.

FIG. 6 is a block diagram of the fuel cell system of an embodiment of the present invention.

### DESCRIPTION OF THE PREFERRED EMBODIMENTS

Hereinafter, the embodiments of the present invention will be explained.

The fuel cell system described in the embodiments includes a fuel cell for generating power by supplying fuel gas containing hydrogen to an anode which is a fuel pole and supplying air containing oxygen to a cathode which is an air pole and a water penetration membrane-type moistening device for collecting moisture of cathode off gas discharged from the exit side of the cathode of the fuel cell and moistening cathode gas, wherein on a pipe of the cathode off gas line for connecting the cathode exit side of the fuel cell and water penetration membrane-type moistening device, a means for regulating the cathode off gas moistening condition is installed.

As a moisture regulating means for regulating the cathode off gas moistening condition, on a pipe line for connecting the cathode exit side of the fuel cell and water penetration membrane-type moistening device, a cathode off gas bypass line for dividing the flow of cathode off gas is installed.

On the cathode off gas bypass line, various means for regulating the flow rate of cathode off gas such as a valve are installed. Various means for regulating the flow rate of cathode off gas supplied to the water penetration membrane-type moistening device according to the power generation condition of the fuel cell, temperature, cell voltage, and dew point temperature are controlled. By doing this, the moistening amount for cathode gas is restricted, thus the water incoming and outgoing balance in the fuel cell can be kept.

The power generation condition is classified into three conditions such as a case that the load applied to the fuel cell is in the rated load condition, a case that it is in the partial load condition, and a case that it is in the overload condition. In the rated load condition, there is no need to bypass cathode off gas and the water incoming and outgoing balance is in the optimum condition. Further, in the partial load condition, the load is in a load condition lower than that at time of the rated load and the generated water is less than that at time of the rated load, so that also in this case, there is no need to bypass cathode off gas. In the overload condition in which the load is higher than that in the rated load condition, the generated water in the fuel cell increases, so that the moisture contained in cathode off gas increases. Therefore, the moistening amount of cathode gas moistened by cathode off gas increases, so that excessive water is supplied to the fuel cell. As a result, the reaction gas flow path in the fuel cell is blocked, and each cell voltage is varied, and the power generation condition becomes unstable. It is necessary to bypass a part of cathode off gas and regulate appropriately the moisture of cathode off gas.

When observing the cell voltage, in the condition of power generation in the rated load condition, when several unspecified cell voltages act unstably or drop, condensed water may be formed in the fuel cell, thus it is necessary to bypass a part of cathode off gas. Here, the cell voltage may be the voltage of a single cell and a plurality of single cells are blocked, thus the voltage may be detected.

When observing the fuel cell stack temperature, if the fuel cell stack temperature is higher than the operation temperature (the temperature at which the fuel cell system can be operated stably), the moisture amount contained in cathode off gas increases, so that it is necessary to bypass a part of cathode off gas.

When the dew point temperature at the exit of at least either of fuel gas and oxidizing agent gas of the fuel cell stack is observed, the moisture amount in the fuel cell can be confirmed more in detail and according to the dew point temperature detected, the cathode off gas bypass line is controlled so as to bypass a part of cathode off gas. For example, when the dew point temperature of fuel gas or oxidizing agent gas is higher than a predetermined value, a part of cathode off gas is bypassed.

Under the above control, even if the power generation condition of the fuel cell is the overload condition, power can be generated without increasing the flow rate of oxidizing agent gas. Therefore, the water incoming and outgoing balance in the fuel cell can be kept always in the appropriate state.

Hereinafter, the concrete embodiments will be explained with reference to the accompanying drawings.

### First Embodiment

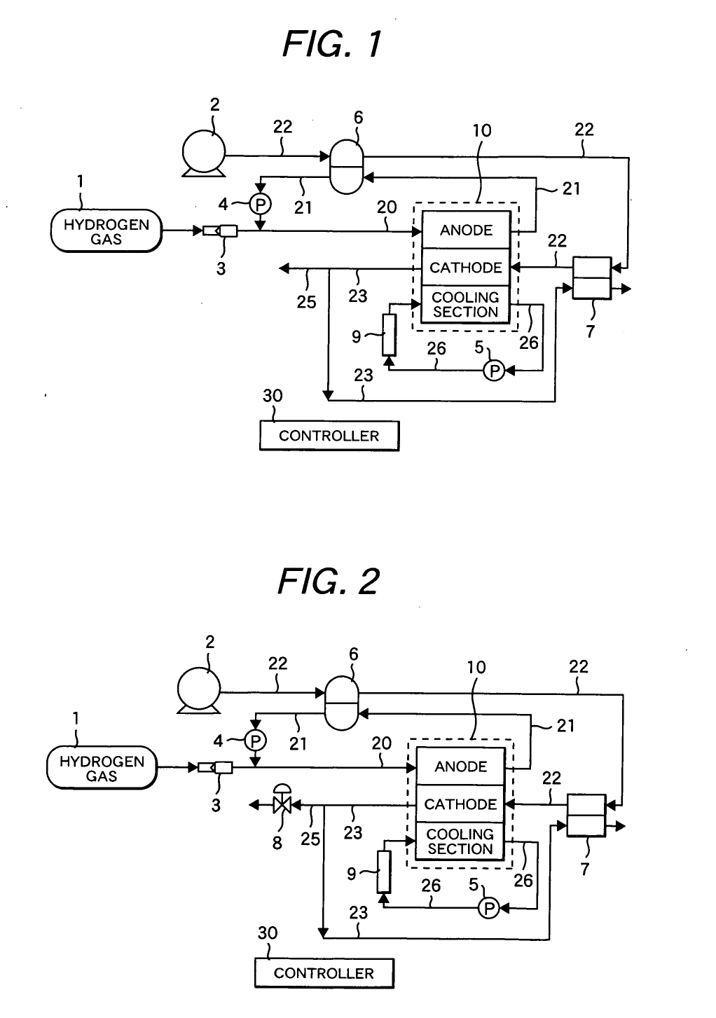

FIG. 1 is a drawing showing the whole constitution of the fuel cell system relating to the first embodiment of the present invention.

As shown in FIG. 1, this embodiment has a fuel cell 10.

The fuel cell 10 uses a polymer electrolyte membrane as an electrolyte membrane and forms an electrode surface coated with carbon carrying platinum on both sides of the membrane. The anode side which is a fuel pole forms a carbon electrode carrying platinum or platinum alloyed with ruthenium. The cathode side which is an air pole forms a carbon electrode carrying platinum. Furthermore, the outside thereof, to supply reaction gas to both electrode surfaces, is grasped by the separators forming the gas flow path. This is called a single cell and the fuel cell stack is composed of several laminated single cells. In FIG. 1, the fuel cell 10 is shown in the simplified state.

The fuel cell 10 includes an anode supplied with fuel gas containing hydrogen, a cathode supplied with oxidizing agent gas containing oxygen, and a cooling section for cooling the fuel cell 10. Further, the fuel cell 10 has a supply port and a discharging port of fuel gas, oxidizing agent gas, and cooling fluid.

In this fuel cell system, fuel gas containing hydrogen supplied from a fuel gas supply means 1 is supplied to the fuel cell 10 via a fuel gas pressure control valve (hereinafter, referred to as a regulator 3) having a solenoid valve function and through an anode supply line 20.

Here, the regulator 3 as a pressure control means is a valve for regulating the supply amount of fuel gas and in this case, controls so as to always keep the pressure in the anode of the fuel cell 10 and pipe thereof constant. Further, the anode supply line 20 indicates a pipe line through which fuel gas is supplied to the anode.

As shown in the drawing, unreacted fuel gas (anode off gas) discharged from the anode exit side of the fuel cell 10 passes through an anode circulation line 21, is supplied to a water penetration membrane-type moistening device 6, and then is circulated again to the anode supply line 20 by a hydrogen pump 4.

The anode circulation line 21 is a pipe line through which anode off gas passes, and although the pipe is not restricted particularly, to prevent vapor contained in anode off gas from condensing, the inside of the pipe line is preferably insulated thermally at a fixed temperature by an insulation material.

The water penetration membrane-type moistening device 6 removes moisture contained in anode off gas. The water penetration membrane-type moistening device 6 has a water penetration membrane, lets anode off gas flow on one side surface across the water penetration membrane, and lets oxidizing agent gas flow on the opposite pole surface. At this time, when the two gases flow so that the gas flows become opposite flows, the moisture contained in anode off gas can be removed more efficiently. The water penetration membrane is a membrane for penetrating water so as to make the partial pressures of vapor of gases facing each other across the membrane equal. The moisture contained in anode off gas can be moved to oxidizing agent gas by the water penetration membrane-type moistening device 6.

As a water penetration membrane installed in the water penetration membrane-type moistening device 6, a macromolecular membrane having high gas barrier properties and water permeability is used. Any water penetration membrane having high gas barrier properties and water permeability is applicable. By use of it, anode off gas does not mix in oxidizing agent gas flowing on the opposite side across the water penetration membrane and the moisture in anode off gas can be removed.

Further, the water penetration membrane may be formed in any shape, though it is preferably formed as a hollow string membrane, and by use of it, the pressure losses of the anode circulation line 21 and cathode supply line 22 can be reduced. In this case, when a fluid of high pressure is used as gas flowing inside the hollow string membrane, an increase in the pressure loss due to collapse of the hollow string can be prevented.

Unreacted fuel gas discharged from the water penetration membrane-type moistening device 6 is supplied to the anode supply line 20 by the hydrogen pump 4. In this case, the hydrogen pump is not restricted particularly, though it is preferable that the maximum flow rate of the hydrogen pump can ensure a fuel gas flow rate at which the fuel use rate indicating the fuel supply amount necessary for power generation of the fuel cell 10 is 95% or less.

The system for recirculating unreacted fuel gas like this does not discharge the unreacted fuel gas outside the system, so that a fuel cell system having good fuel efficiency can be obtained.

As shown in the drawing, in this fuel cell system, oxidizing agent gas containing oxygen supplied from an oxidizing agent gas supply means 2 (blower) passes through a cathode supply line 22 and the water penetration membrane-type moistening devices 6 and 7 and is supplied to the fuel cell 10.

Here, the cathode supply line 22 is a line through which oxidizing agent gas is supplied to the cathode and in the water penetration membrane-type moistening device 6, moves moisture contained in anode off gas to oxidizing agent gas.

The water penetration membrane-type moistening device 7 is arranged to moisten oxidizing agent gas and similarly to the water penetration membrane-type moistening device 6, has a macromolecular membrane for penetrating water and any macromolecular membrane having high gas barrier properties and water permeability can be used. The shape and structure of the water penetration membrane and the gas flowing direction when a hollow string is used are the same as those of the water penetration membrane-type moistening device 6. Further, in this case, the flow rate of oxidizing agent gas on the moistened side, compared with cathode off gas used for moistening, is high, so that in the case of the hollow string shape, it is preferable to let oxidizing agent gas flow internally.

Here, a cathode off gas line 23 is a pipe line through which cathode off gas flows, and although the pipe is not restricted particularly, to prevent vapor contained in cathode off gas from condensing to water and blocking the flow path in the pipe, a structure of covering the pipe surface with an insulation material and keeping the temperature of the cathode off gas line 23 in the pipe is preferable.

The means for observing the power generation condition of the fuel cell 10 is not drawn, though the load current of the fuel cell 10 is monitored and controlled by a controller 30.

Here, the controller 30 is composed of a microcomputer including a CPU, a ROM, and a RAM and its peripheral circuit. And, the controller 30, although not drawn, has means for detecting and monitoring the load current of the fuel cell 10, fuel cell stack temperature, and each fuel cell voltage.

As shown in the drawing, in the fuel cell system, the fuel cell stack temperature of the fuel cell 10 is regulated by cooling water and cooling water discharged from the cooling section of the fuel cell 10 is supplied to a water pump 5 via a cooling water circulation line 26. Cooling water discharged from the water pump 5 is supplied again to the cooling section of the fuel cell 10 via a radiator 9.

Here, the cooling water circulation line 26 is a pipe line through which cooling water flows and the water pump 5 is a pump for forcibly circulating cooling water. The water pump 5 is not restricted particularly, though if possible, it is preferable that the use limit temperature and maximum water discharge pressure of the water pump 5 are equal to or more than the operation temperature of the fuel cell 10 and the pressure loss of the cooling section.

Further, the radiator 9 decreases the cooling water temperature raised by the fuel cell 10 down to an appropriate temperature, and a cooling fan (not drawn) is in contact with the heat radiation surface of the radiator 9 and is operated depending on the fuel cell stack temperature of the fuel cell 10.

As shown in the drawing, the fuel cell system has a line through which cathode off gas discharged from the cathode of the fuel cell 10 passes the cathode off gas line 23 and bypasses to a cathode off gas bypass line 25 and cathode off gas not bypassing is ejected outside the system via the water penetration membrane-type moistening device 6.

The cathode off gas bypass line 25, when the power generation condition of the fuel cell 10 is put into the overload condition, is a pipe for discharging a part of cathode off gas outside the system and when the cathode off gas bypass line 25 is opened, a part of cathode off gas can be discharged outside the system before entering the moistening device 7.

In this case, cathode off gas flowing through the cathode off gas bypass line 25 is connected to a pipe through which about 10% of cathode off gas flows through the cathode off gas bypass line 25.

The concrete control method will be described in the third embodiment.

As mentioned above, according to the first embodiment, as shown in FIG. 4, when cathode off gas bypasses, even if the power generation condition of the fuel cell 10 is the overload condition, the fuel cell 10 can generate power up to about 1.5 times of the rated load current.

### Second Embodiment

The differences from the first embodiment will be described below.

As shown in the drawing, the fuel cell system has a line through which cathode off gas discharged from the cathode of the fuel cell 10 passes through the cathode off gas line 23 and bypasses to the cathode off gas bypass line 25 and a cathode off gas bypass valve 8 and cathode off gas not bypassing is ejected outside the system via the water penetration membrane-type moistening device 6.

The cathode off gas bypass line 25, when the power generation condition of the fuel cell 10 is put into the overload condition, is a pipe for discharging a part of cathode off gas outside the system and controls the discharge amount of cathode off gas by the cathode off gas bypass valve 8 stepwise according to the load current.

The concrete control method will be described in the fourth embodiment.

As mentioned above, according to the second embodiment, as shown in FIG. 4, the flow rate of bypassing cathode off gas is controlled according to the load current, thus even if the power generation condition of the fuel cell 10 is the overload condition, the fuel cell 10 can generate power up to about 1.8 times of the rated load current.

### Comparison Embodiment

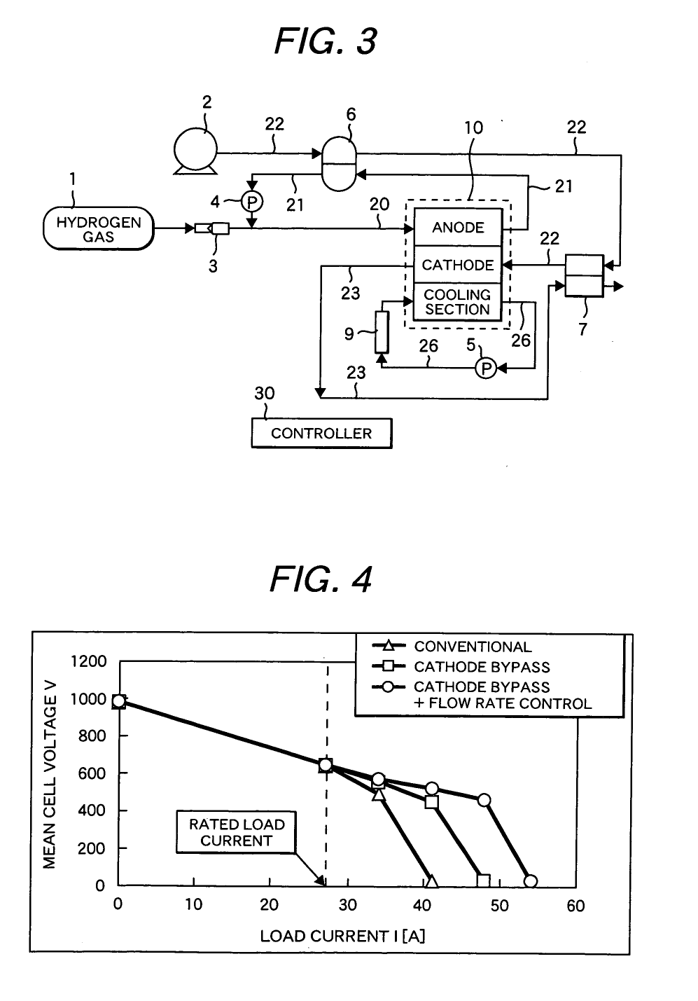

FIG. 3 is a drawing showing the whole constitution of the comparison embodiment for the fuel cell system relating to the embodiments of the present invention.

According to the comparison embodiment shown in FIG. 3, in a fuel cell system having no line for bypassing cathode off gas, even if the power generation condition of the fuel cell 10 is the overload condition, as shown in FIG. 4, the fuel cell 10 can generate power up to about 1.3 times of the rated load current.

### Third Embodiment

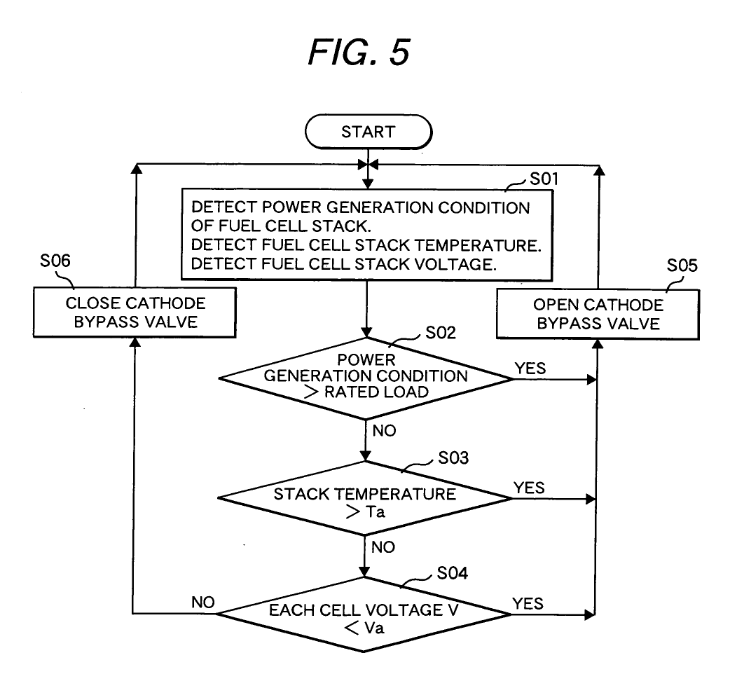

The fuel cell controlling method using the fuel cell system shown in FIG. 1 will be explained below by referring to FIG. 5. Concretely, the basic control method for the cathode off gas line 23 will be explained.

Firstly, at the start stage, after the fuel cell system starts, the power generation condition of the fuel cell 10 moves to the rated load condition.

After moving to the rated load condition, at Step S01, the controller 30 monitors the power generation condition of the fuel cell 10, fuel cell stack temperature, and each fuel cell voltage.

At Step S02, the controller 30, when judging that the power generation condition of the fuel cell 10 exceeds the rated load condition, moves toward YES and at Step S05, sends a signal to the cathode off gas bypass valve 8 so as to open it.

At Step S02, the controller 30, when judging that the power generation condition of the fuel cell 10 is lower than the rated load condition, moves toward NO and moves to Step S03.

At Step S03, the controller 30, when judging that the fuel cell stack temperature Ta at time of the rated load of the fuel cell 10 is higher than the fuel cell stack temperature T, moves toward YES and at Step S05, sends a signal to the cathode off gas bypass valve 8 so as to open it.

At Step S03, the controller 30, when judging that the fuel cell stack temperature of the fuel cell 10 is lower than that in the rated load condition, moves toward NO and moves to Step S04.

At Step S04, the controller 30, when judging that each cell voltage Va at time of the rated load of the fuel cell 10 is higher than each cell voltage V, moves toward YES and at Step S05, sends a signal to the cathode off gas bypass valve 8 so as to open it.

At Step S04, the controller 30, when judging that each cell voltage V of the fuel cell 10 is equal to or lower than each cell voltage in the rated load condition, moves toward NO and moves to Step S06.

At Step S06, the controller 30 sends a signal to the cathode off gas bypass valve 8 so as to close it and the fuel cell system executes the ordinary control.

And, again in the state of S01, the controller 30 monitors the power generation condition of the fuel cell 10, fuel cell stack temperature, and each fuel cell voltage.

As mentioned above, the controller 30, when the power generation condition of the fuel cell system is the overload condition, monitors the power generation condition of the fuel cell 10, fuel cell stack temperature, or each cell voltage of the fuel cell 10 and if the fuel cell is put into an unstable state such as a rise of the stack temperature or a drop of each cell voltage when the power generation condition is the overload condition, controls the cathode off gas bypass valve 8 so as to appropriately regulate the flow rate of cathode off gas, thus a stable fuel cell system can be provided.

### Fourth Embodiment

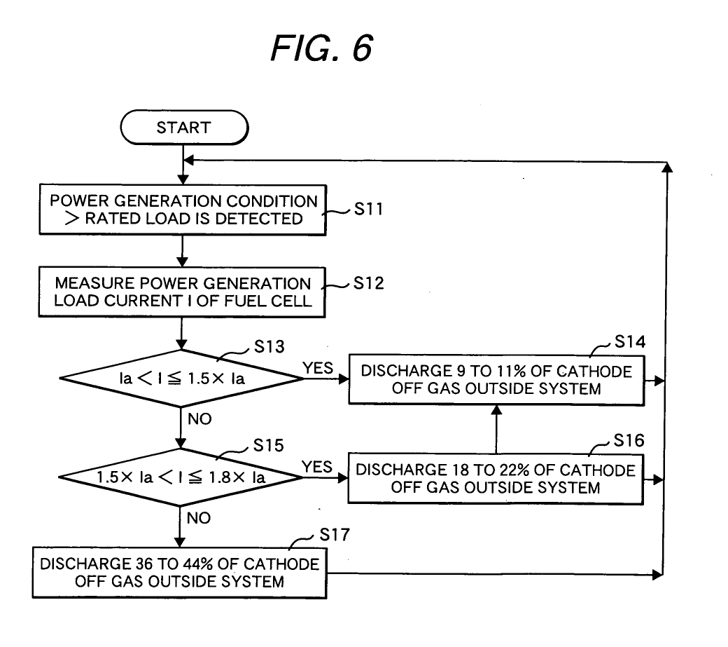

The fuel cell controlling method using the fuel cell system shown in FIG. 2 will be explained below by referring to FIG. 6. Concretely, the control method for the cathode off gas bypass valve 8 will be explained.

Firstly, at the start stage, after the fuel cell system starts, the power generation condition of the fuel cell 10 moves to the rated load condition.

Step 11 shows the state when YES is judged at Step S02 shown in FIG. 5.

At Step S12, the controller 30 monitors the detected value using a means (not drawn) for detecting the load current I applied to the fuel cell 10.

At Step S13, the controller 30, when judging that the detected value of the load current I applied to the fuel cell 10 is above the rated load current Ia up to 1.5 times of the rated load current Ia, selects YES and moves to Step S14. At Step S14, the controller 30 controls the cathode off gas bypass valve 8 so as to discharge 9 to 11% of the overall flow rate of cathode off gas outside the system.

At Step S13, the controller 30, when judging that the load current I applied to the fuel cell 10 is higher than 1.5 times of the rated load current Ia, selects NO and moves to Step S15.

At Step S15, the controller 30, when judging that the detected value of the load current I applied to the fuel cell 10 is above 1.5 times of the rated load current Ia up to 1.8 times of the rated load current Ia, selects YES and moves to Step S16. At Step S16, the controller 30 controls the cathode off gas bypass valve 8 so as to discharge 18 to 22% of the overall flow rate of cathode off gas outside the system.

At Step S15, the controller 30, when judging that the load current I applied to the fuel cell 10 is higher than 1.8 times of the rated load current Ia, selects NO and moves to Step S17.

At Step S17, the controller 30 detects the load current I applied to the fuel cell 10 which is higher than 1.8 times of the rated load current Ia. In this case, the controller 30 controls the cathode off gas bypass valve 8 so as to discharge 36 to 44% of the overall flow rate of cathode off gas outside the system.

And, again in the state of S01, the controller 30 monitors the load current of the fuel cell 10.

As explained above, the controller 30 detects and monitors the load current I applied to the fuel cell 10, controls stepwise the cathode off gas bypass valve 8 according to the detected value, thus insufficient moistening of oxidizing agent gas due to excessive discharge of cathode off gas can be prevented, and oxidizing agent gas can be controlled to an appropriate moistening degree, so that moisture can be supplied to the fuel cell in proper quantities according to the load current. Therefore, a stabler fuel cell system of high output can be provided.

What is claimed is:

1. A fuel cell system comprising a fuel cell for oxidizing fuel gas, reducing oxidizing agent gas, thereby generating power and a water penetration membrane-type moistening device for collecting moisture contained in cathode off gas composed of said reduced oxidizing agent gas and moistening said oxidizing agent gas before reduction, wherein moisture regulating means for regulating said moisture contained in said cathode off gas is installed on a pipe connected to said fuel cell and when said fuel cell is operated at more than a predetermined rated load of said fuel cell, said moisture contained in said cathode off gas is reduced by said moisture regulating means.

2. A fuel cell system according to claim 1, wherein said moisture regulating means has a cathode off gas bypass line for distributing and discharging said cathode off gas outside said system.

3. A fuel cell system according to claim 1, wherein said cathode off gas bypass line is equipped with flow rate regulating means.

4. A fuel cell system according to claim 3, further comprising means for detecting a cell voltage of said fuel cell, wherein according to said cell voltage, said means controls stepwise said flow rate regulating means for said cathode off gas.

5. A fuel cell system according to claim 3, further comprising means for detecting a temperature of said fuel cell, wherein according to said temperature, said means controls stepwise said flow rate regulating means for said cathode off gas.

6. A fuel cell system according to claim 3, further comprising means for detecting dew point temperatures of said fuel gas and/or said oxidizing agent gas, wherein according to detected values of said dew point temperature detection means, said means controls stepwise said flow rate regulating means for said cathode off gas.

7. A fuel cell system comprising a fuel cell for oxidizing fuel gas, reducing oxidizing agent gas, thereby generating power and a water penetration membrane-type moistening device for collecting moisture contained in cathode off gas composed of said reduced oxidizing agent gas and moistening said oxidizing agent gas before reduction, wherein a cathode off gas bypass line for distributing and discharging said cathode off gas outside said system is installed on a pipe connected to said fuel cell, and said cathode off gas bypass line is equipped with flow rate regulating means, and when said fuel cell is operated at more than a predetermined rated load of said fuel cell, according to a power generation load current of said fuel cell, a discharging rate of cathode off gas from said cathode off gas bypass line is changed.

8. A fuel cell system comprising a fuel cell for oxidizing fuel gas, reducing oxidizing agent gas, thereby generating power and a water penetration membrane-type moistening device for collecting moisture contained in cathode off gas composed of said reduced oxidizing agent gas and moistening said oxidizing agent gas before reduction, wherein a cathode off gas bypass line for distributing and discharging said cathode off gas outside said system is installed on a pipe connected to said fuel cell, and said cathode off gas bypass line is equipped with flow rate regulating means, and when said fuel cell is operated at more than a predetermined rated load of said fuel cell, a flow rate of said cathode off gas into said cathode off gas bypass line is regulated by said flow rate regulating means.
